(19) United States
(12) Patent Application Publication
(10) Pub. No.: US 2011/0256506 A1
(43) Pub. Date: Oct. 20, 2011

(54) STUMP FOR DENTAL IMPLANTS

(76) Inventor: Roberto Pancaldi, Camerano (AN) (IT)

(21) Appl. No.: 12/998,922

(22) PCT Filed: Nov. 4, 2009
(86) PCT No.: PCT/EP2009/064650

§ 371 Date: Jun. 16, 2011

(30) Foreign Application Priority Data
Dec. 23, 2008 (IT) MC2008U000040

(51) Int. Cl. A61C 8/00

(52) U.S. Cl. 433/173

(57) ABSTRACT

The present invention relates to a stump for dental implants provided at approximately half of its height with a large disk in horizontal position to favour the balanced stable support of a crown.

The present patent application relates to a stump for dental implants especially provided with particular functional efficacy.

The peculiarities and advantages of the invention will become evident after a short illustration of the prior art.

A dental implant technique is largely used to remedy the loss of a tooth that fell out spontaneously or was extracted by the dentist.

According to this technique, the dentist implants a basically cylindrical metal pin (technically defined as “implant”) that acts as root for the artificial tooth to be installed.

Once a similar implant has stabilised in the bone, a basically conical metal stem, normally defined as “stump”, is fixed by means of a screw.

The stump is adapted to support the dental prosthesis (the so-called “crown”), that is to say the jacket crown that exactly represents the missing natural tooth.

It must be noted that a typical crown is normally formed of a ceramic-coated metal bell.

The coupling between a crown and the corresponding stump is normally obtained by means of suitable cement paste according to a very delicate operation that requires adjusting the quantity of said paste from time to time correctly.

An excess of the paste would result in uncontrolled leakage from the crown, thus causing dangerous paradontitis that can eventually determine the loss of the implant because of rejection.

An alternative technology has been introduced to remedy such a drawback, which uses a resin crown that is built and modelled directly on the stump before the stump is fixed to the implant.

The stump is preferably provided with some milled areas that originate undercut points to favour the adhesion of the resin.

Once the “crown-stump” assembly has been realised, the assembly is fixed to the implant (which has been already implanted in the patient's bone) by means of a screw with basically vertical axis that crosses the assembly in a through hole.

The upper opening of the hole is adapted to be closed with a suitable quantity of prosthesic paste.

It must be noted, however, that this advanced technology is impaired by some drawbacks, the most significant of which being the poor stability of the resin crown with respect to the metal stump, due to the high mechanical stress caused by chewing.

In particular, such a lamentable problem occurs when the crown has a much wider section than the stump, as in the case of a crown reproducing the shape and dimensions of a molar tooth.

It can be otherwise said that such a crown tends to destabilize, especially in the peripheral areas, because of the lack of homogeneous support.

The specific purpose of the present invention is to innovate the aforesaid technique, with the specific intention to provide the resin crown with perfect stability with respect to the bearing stump, also in case of crowns with large width.

The inventive idea that has allowed to obtain such an advantageous result consists in increasing the carrying capacity of a stump, in such a way that the stump forms a support area for the resin crown that extends beyond the width of its specific section.

This result has been obtained by providing the stump of the invention, in an intermediate point of its height, with at least one perimeter groove energetically coupled with a metal disk with central hole inserted from up down on the stump.

In view of the above, the disk projects all around the stump, thus creating a large horizontal surface that provides efficacious support and anchoring for the resin of the crown.

Moreover, it must be noted that the fact that the aforesaid disk is an optional accessory of the stump, the stump can be also used in the traditional configuration (that is to say without such a disk) whenever the crown does not require “enlarged” support.

Although the aforesaid “modular” version of the stump of the invention is certainly the most advantageous embodiment from an economic and functional viewpoint, the perimeter disk can be irreversibly integrated in the stump according to a basically monolithic constructive solution.

It must be noted that within the same inventive idea the stump of the invention could be provided with different technical solutions to enlarge the support area for the crown.

For instance, an alternative disk provided with a series of regularly spaced radially notches could be used.

The aforesaid disks can be “ground” by milling as desired by the dentist (especially in the monolithic version of the stump of the invention) in case of special support needs of the crown.

For purposes of clarity, the description of the invention continues with reference to the enclosed drawing, which is intended for purposes of illustration only and not in a limiting sense, wherein:

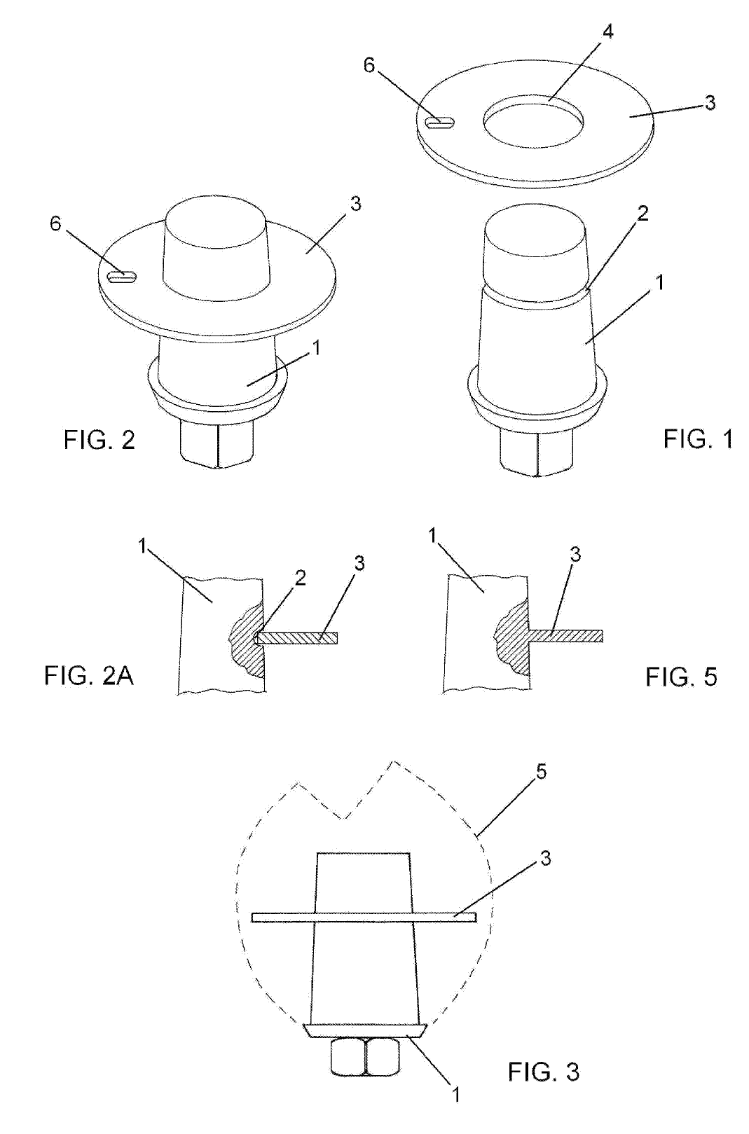

FIG. 1 is an exploded axonometric view of the stump of the invention with disk in non-operative condition;

FIG. 2 is an axonometric view of the stump of the invention with disk in operative condition;

FIG. 2A is a partially cross-sectional view of an enlarged detail of FIG. 2

FIG. 3 is a view of the stump of FIG. 2 complete with crown;

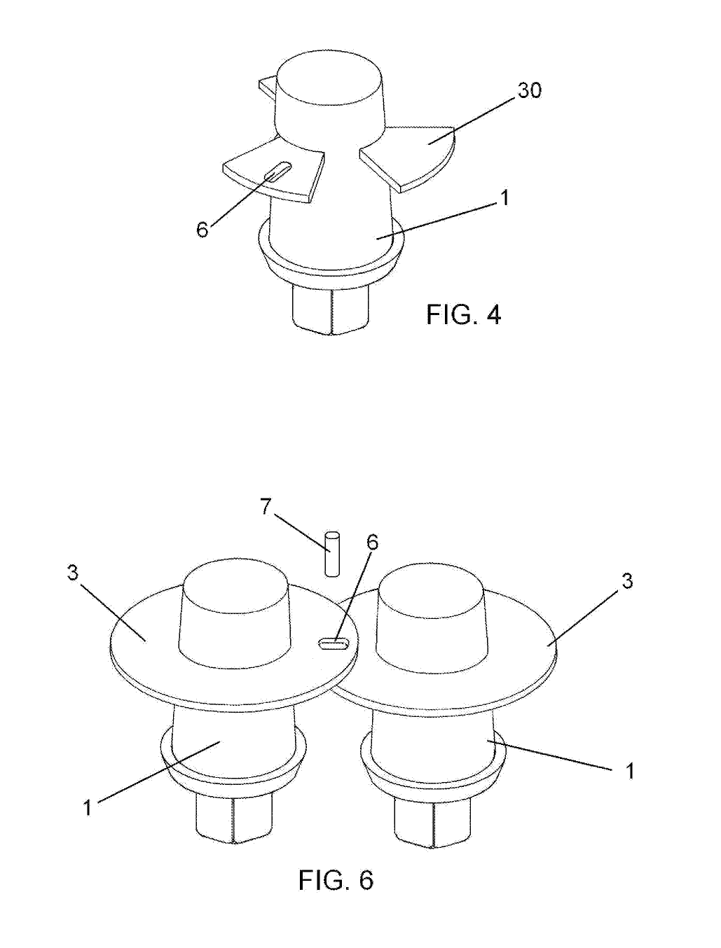

FIG. 4 is the same as FIG. 2, except for it refers to an alternative embodiment of the stump of the invention;

FIG. 5 is the same as FIG. 2A, except for it refers to a further constructive embodiment of the stump of the invention;

FIG. 6 is an axonometric view of a cooperating pair of the stump of the invention.

Referring to FIG. 1, the stump of the invention (1), which normally has the structure of a basically conical stem, is characterised in that it is provided with a thin perimeter groove (2) in an intermediate point of its height.

As mentioned above, the stump (1) is adapted to cooperate with a disk (3) provided with a central hole (4). The diameter of the hole (4) basically corresponds to the thickness of the stump (1) on the bottom of the groove (2).

The coupling between the two parts is obtained when the disk (3) is inserted from up down on the stump (1) through the central hole, as shown in FIG. 2.

Considering that the conical stump (1) is preferably provided with increasing section from the tip to the lower end, it appears evident that the edge of the hole (4) of the disk (3) tends to increasingly rub against the external walls of the stump (1) during its descending travel, until it is inserted into said groove (2).

The above provides the very stable coupling between stump (1) and disk (3), thus ensuring that the perimeter projecting area of the disk (1) can easily withstand the weight of the resin of the crown (5) and the stress transmitted by the crown (5) during chewing.

Apart from what expressly shown in FIG. 1, it is understood that, in addition to said first groove (2), the stump of the invention could also be provided with one or two additional identical grooves at different heights; this would allow the dentist to mount the disk (3) at the most suitable height according to the specific characteristics of the crown (5).

As mentioned above, the stump of the invention could also be realised in monolithic version, in which said disk is obtained “in one piece” in the structure of the stump, as shown in FIG. 5.

Referring to FIG. 4, the stump (1) is provided with a disk (30) with different configuration, being provided with a regularly spaced series of radial notches.

Also in this case, the disk (30) can be of the type adapted to be coupled with the corresponding stump or obtained “in one piece” in the structure of the stump.

Finally, it must be noted that the aforesaid embodiments of the disk (3, 30) could be also provided with a through slot (6), preferably obtained in a peripheral point, as shown in FIG. 6.

Such a slot (6) has been devised to provide stable connection between the disks (3, 30) of two adjacent stumps (1), thus obtaining a common bearing area for the crowns, as expressly shown in FIG. 6.

In this case, the disks (3, 30) of the two adjacent stumps (1) are arranged in such a way that the first one can partially surmount the second one and the slots (6) are in vertical alignment.

Now the stable coupling between the disks (3, 30) can be easily obtained by means of a plug with vertical axis (7) that simultaneously crosses the slots (6).

1. Dental prosthesis comprising:
a stump (1) composed of a circular stem suitable to be coupled to a dental implant implanted in the patient's bone, and
a resin crown (5) that exactly represents the missing natural tooth, said resin crown (5) supported by said stump (1), characterised in that said stump (1) comprises a disk (3, 30) arranged in horizontal position with higher diameter than the corresponding section of the stump (1); said disk (3, 30) being arranged in an intermediate point of height of the stump (1) so that the disk (3, 30) provides anchoring for the resin of the crown (5).

2. Dental prosthesis as claimed in claim 1, wherein said stump (1) is provided with at least one perimeter groove (2) and said disk (3) is provided with circular hole (4) obtained in the centre of the disk (3, 30), said perimeter groove (2) being adapted to be selectively coupled with the perimeter edge of the circular hole (4) of the disk, when the disk is inserted on the stump (1) from up down.

3. Dental prosthesis as claimed in claim 1 wherein the disk (30) is provided with a series of radial notches.

4. Dental prosthesis as claimed claim 1, wherein the disk (3, 30) is provided in a peripheral point with a slot (6) adapted to be crossed by a corresponding plug (7), in order to provide stable connection between the disks (3, 30) of two adjacent stumps (1), thus obtaining a common bearing area for the crowns (5).
